(19) United States
(12) Patent Application Publication
(10) Pub. No.: US 2024/0178400 A1
(43) Pub. Date: May 30, 2024

(54) CARBON NANOFOAMS WITH GRADED/GRADIENT PORE STRUCTURE

(71) Applicant: The Government of the United States of America, as represented by the Secretary of the Navy, Arlington, VA (US)

(72) Inventors: Megan B. Sassin, Arlington, VA (US); Jeffrey W. Long, Alexandria, VA (US); Debra R. Rolison, Arlington, VA (US)

(73) Assignee: The Government of the United States of America, as represented by the Secretary of the Navy, Arlington, VA (US)

(21) Appl. No.: 18/432,903

(22) Filed: Feb. 5, 2024

Related U.S. Application Data
(63) Continuation of application No. 16/678,389, filed on Nov. 8, 2019, now abandoned.
(60) Provisional application No. 62/757,969, filed on Nov. 9, 2018.

(51) Int. Cl. H01M 4/62; B82Y 30/00; H01M 4/02; H01M 4/04; H01M 4/50; H01M 4/86; H01M 4/96

(52) U.S. Cl. CPC H01M 4/625; H01M 4/043; H01M 4/50; H01M 4/622; H01M 4/861; H01M 4/96; B82Y 30/00; H01M 2004/021

(57) ABSTRACT

A laminated article having a first layer and a second layer. Each layer has a porous carbon structure and a porous polymer. The pores of the two porous polymers are from 1 nanometer to 10 microns in diameter, and the two porous polymers have different pore size distributions. A method of making the laminated article by hot-pressing the two or more layers. The article may be used in an electrochemical cell.

### REFERENCE TO RELATED APPLICATIONS

This application is a continuation application of U.S. application Ser. No. 16/678,389, filed on Nov. 8, 2019, which claims the benefit of U.S. Provisional Application No. 62/757,969, filed on Nov. 9, 2019. The provisional application and all other publications and patent documents referred to throughout this nonprovisional application are incorporated herein by reference.

### TECHNICAL FIELD

The present disclosure is generally related to carbon nanofoams.

### DESCRIPTION OF THE RELATED ART

The performance of existing energy-storage and -conversion devices (e.g., batteries, supercapacitors, fuel cells) will fall short of the demanding power metrics of future technologies, which will require high capacity at high rates. In applications where high energy content is required, batteries are the solution of choice, but they often cannot deliver that energy at high rates. Conversely, if high rate is required, then supercapacitors are the technology of choice, but they often fail to supply the requisite energy density. Fuel cells are energy-dense but have limited power. In each of these cases, the ability to deliver or store/convert energy is largely dependent on the structures of the incorporated electrodes. Conventional electrodes are fabricated as composites of powders and polymeric binders. The resulting ad hoc pore-solid structure does not provide optimized transport pathways for electrons, ions, and molecules through the macroscale volume of the electrode, ultimately limiting power/energy performance.

Some of these limitations can be circumvented by designing electrode structures that have inherently through-connected pore structures of tunable pore sizes and “wired” electron pathways, expressed in a binder less, freestanding electrode at device-relevant dimensions (Rolison et al., Multifunctional 3-D nanoarchitectures for energy storage and conversion. Chem. Soc. Rev., 38, 226 (2009)). Fiber-paper-supported carbon nanofoams meet these stringent criteria (Lytle et al., The right kind of interior for multifunctional electrode architectures: Carbon nanofoam papers with aperiodic submicrometer pore networks interconnected in 3D. Energy Environ. Sci., 4, 1913 (2011)). The efficacy of such electrode architectures for applications that include supercapacitors, metal-air batteries, and lithium-ion batteries, where the surfaces of the carbon nanofoam within the carbon-fiber paper are modified with nanoscale coatings (e.g., metal oxides) to achieve the desired charge storage or catalytic functionality has been demonstrated. This first-generation of carbon nanofoam papers was designed and fabricated to exhibit particular pore structures, depending on the end-use-smaller pores to yield higher surface area and associated higher capacity; moderate pore sizes to support both rate and capacity; and large pores to accommodate the formation of reaction products (Chervin et al., Carbon nanofoam-based cathodes for Li—O₂ batteries: Correlation of pore-solid architecture and electrochemical performance. J. Electrochem. Soc., 9, A1510 (2013)).

### SUMMARY OF THE INVENTION

Disclosed herein is an article comprising: a first layer comprising a first porous carbon structure and a first porous polymer; and a second layer comprising a second porous carbon structure and a second porous polymer. The pores of the first porous polymer and the second porous polymer are from 1 nanometer to 10 microns in diameter. The first porous polymer and the second porous polymer have different pore size distributions.

Also disclosed herein is a method comprising: providing a first layer comprising a first porous carbon structure and a first porous polymer; providing a second layer comprising a second porous carbon structure and a second porous polymer; and forming a laminated article comprising the first layer and the second layer. The pores of the first porous polymer and the second porous polymer are from 1 nanometer to 10 microns in diameter. The first porous polymer and the second porous polymer have different pore size distributions.

### BRIEF DESCRIPTION OF DRAWINGS

A more complete appreciation will be readily obtained by reference to the following Description of the Example Embodiments and the accompanying drawings.

FIG. 1 schematically illustrates a two layer structure.

FIG. 2 schematically illustrates a gradient structure.

FIG. 3 schematically illustrates an alternating structure.

FIG. 4 schematically illustrates an electrochemical cell incorporating two of the laminated articles.

FIG. 5 schematically illustrates the process to produce graded/gradient carbon nanofoam papers.

FIGS. 6A and 6B show optical images of the two sides of a 50/500|40/1500-graded pore polymer nanofoam paper after hot-pressing (FIG. 6A) and after pyrolysis to form the graded pore carbon nanofoam paper (FIG. 6B).

FIGS. 7A and 7B show scanning electron micrographs of the cross-sections of graded pore carbon nanofoams at low magnification (FIG. 7A) and high magnification (FIG. 7B).

FIG. 8 shows incremental pore volume versus pore width from N₂ sorption porosimetry on hot-pressed 50/500|50/500 (dash line), hot-pressed 40/500|40/500 (solid line), and graded 50/500|40/500 (dash dot line).

FIGS. 9A-D show specific capacitance versus voltage for MnOx-carbon nanofoam|MnOx-carbon nanofoam electrochemical capacitors comprised of different carbon nanofoam electrodes at (FIG. 9A) 5 mV s⁻¹ and (FIG. 9B) 25 mV s⁻¹. (FIG. 9C) Bode plot of the real component of specific capacitance versus frequency for MnOx-carbon nanofoam|MnOx-carbon nanofoam electrochemical capacitors at 0.4 V and (FIG. 9D) Bode plot of the imaginary component of capacitance versus frequency for MnOx-carbon nanofoam|MnOx-carbon nanofoam electrochemical capacitors.

### DETAILED DESCRIPTION

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Next-generation electrochemical devices may incorporate electrode structures designed to express high surface area to provide ample sites for charge storage or catalytic reactions that are in turn fed by large pores in which diffusion is relatively unimpeded. For example, fuel-cell electrodes and air cathodes for metal-air batteries should have more open pore structures at their outer face (away from the electrolyte) such that oxidant (or fuel) easily transports through the electrode volume to the active sites that may be concentrated toward the electrolyte-facing side of the electrode.

With these design considerations in mind, a simple approach to fabricate graded/gradient-pore electrode architectures has been developed. Herein, the methods used to fabricate such electrodes, characterization of their multilayer structures, and preliminary demonstrations of performance in simple electrochemical devices are described.

Disclosed herein is the fabrication of a freestanding electrically conductive 3D scaffold (e.g., carbon nanofoam) that possesses a graded/gradient pore structure in the z-direction of the object (e.g., through the thickness of a paper-like structure). The fabrication method is based on hot-pressing multiple layers of polymer nanofoam-filled carbon-fiber papers with pre-selected pore size distributions to form a multilayer structure. Subsequent pyrolysis of said multilayer polymer nanofoam-filled paper yields electrically conductive carbon nanofoam paper, with the discrete layers of varying pore structure adhered in a mechanically stable laminate.

The disclosed structure has at least two discrete layers that are laminated together by, for example, hot-pressing. Each of the two of more layers comprises a porous carbon structure as a scaffold, infiltrated by a porous polymer. These layers may be made by methods such as those disclosed in Sassin et al., Designing high-performance electrochemical energy-storage nanoarchitectures to balance rate and capacity. Nanoscale, 5, 1649 (2013) and Lytle et al., The right kind of interior for multifunctional electrode architectures: carbon nanofoam papers with aperiodic submicrometre pore networks interconnected in 3D. Energy Environ. Sci., 4, 1913 (2011).

The pores allow for transport of reactants and products throughout the structure. The polymers in each of these layers comprise pores that are from 1 nanometer to 10 microns in diameter. Other pores outside this range may also be present as long as least some, a majority, or at least 90% of the pores are in this range. FIG. 1 schematically illustrates a two layer structure. The white areas represent the pores of the polymer.

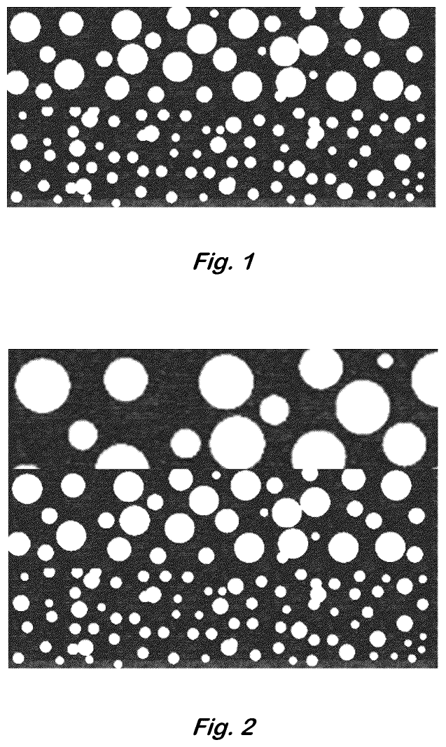

At least two of the layers have different pore size distributions from each other. The pore size distribution may be based on all of the pores that are present in the polymer, or may be based on just the pores in the range of 1 nm to 10 μm. The pore size distribution may include the average size, the size range in which a majority or 90% of the pores fall, or the full histogram of pore sizes. The structure may also comprise additional such layers, all having different pore size distributions. The distributions across multiple layers may form a gradient from one surface of the structure to the opposite surface. For example, the average pore size may increase or decrease through the structure. FIG. 2 schematically illustrates a gradient structure.

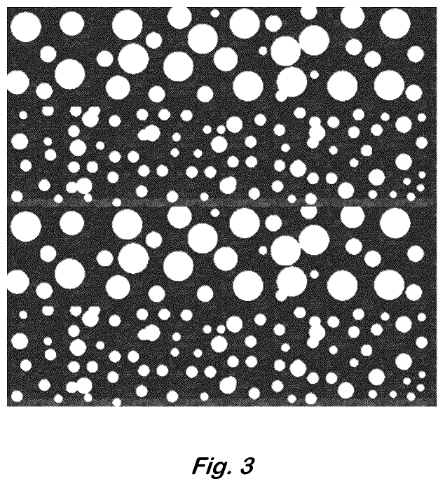

It is not required that every layer have a different pore size distribution as long as at least two of the layers are different. Further layers may have the same or different distributions. For example, the structure may alternate between two types of layers. The structure may also have additional layers that are not of the porous carbon/porous polymer form, as long as there are at least two such layers present. FIG. 3 schematically illustrates an alternating structure

One suitable porous carbon structure is a carbon fiber paper, however any porous carbon structure known in the art that may be laminated into the structure may be used. The two or more layers may contain the same or different types of carbon structure.

One suitable polymer is a polymer of resorcinol and formaldehyde, however any polymer that can infiltrate into the voids of the carbon-fiber paper and also be porous itself may be used. The two or more layers may use the same or different polymers. The polymer may be formed by infiltrating the carbon with monomer, followed by polymerization, as described below. The pores in the polymer layers may form a connected network of pores permeating the structure.

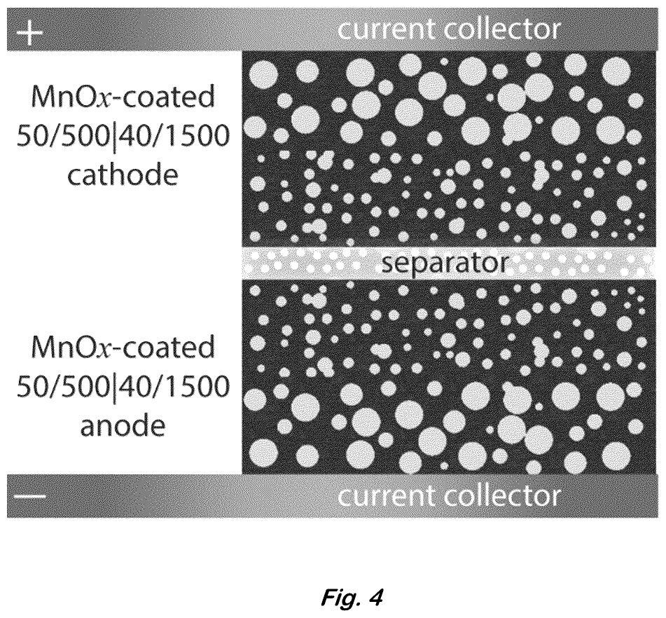

The polymer may have a desired electrochemical activity. The polymer may also be coated with a material with a desired electrochemical activity. One such example material is manganese oxide. FIG. 4 schematically illustrates an electrochemical cell incorporating two of the laminated articles.

The following examples are given to illustrate specific applications. These specific examples are not intended to limit the scope of the disclosure in this application.

Fabrication of porous polymer nanofoams—Polymer-based nanofoams were prepared according to protocols previously reported (Sassin et al., Designing high-performance electrochemical energy-storage nanoarchitectures to balance rate and capacity. Nanoscale, 5, 1649 (2013)). Briefly, carbon fiber paper was immersed in a resorcinol-formaldehyde (RF) sol under vacuum for 2 minutes. The RF-infiltrated carbon paper was removed from the RF sol, sandwiched between two glass slides, secured with mini binder clips, wrapped in duct tape, and placed inside an Al foil pouch. The Al pouch was then placed inside a pressure cooker on “steam” setting for 9.5 h followed by 12 h at the “warm” setting. The Al pouches were then removed from the pressure cooker; the polymer foam-infiltrated carbon fiber papers were removed from the glass-slide assembly, soaked in 18 Mχ cm water for 1 h, acetone for 1 h, and then dried under ambient laboratory conditions. Distinct pore size distributions in the polymer nanofoam result from variations in the resorcinol-formaldehyde weight percent and the ratio of resorcinol-to-catalyst (Na₂CO₃), R:C, and are labeled as “RF weight percent/R:C ratio” (Table 1).

TABLE 1
RF sol recipes and corresponding pore size distributions

| | Resorcinol | Formaldehyde | Na₂CO₃ | Water | Pore Size |
|---|---|---|---|---|---|
| Recipe | (g) | (g) | (g) | (g) | Distribution^{b} (nm) |
| RF 50/R:C 500 (50/500) | 10 | 14.74 | 0.0193 | 6.17 | 2-45 |
| RF 50/R:C 1500 (50/1500) | 10 | 14.74 | 0.00254 | 3.13 | 2-50 |
| RF 40/R:C 500 (40/500) | 10 | 14.74 | 0.0177 | 13.9 | 2-70 |
| RF 40/R:C 1500 (40/1500) | 10 | 14.74 | 0.00254 | 10.9 | 2-100 |
| μm-RF 40/R:C 1500^{a} | 10 | 14.74 | 0.00254 | 10.9 | 2-1000^{c} |

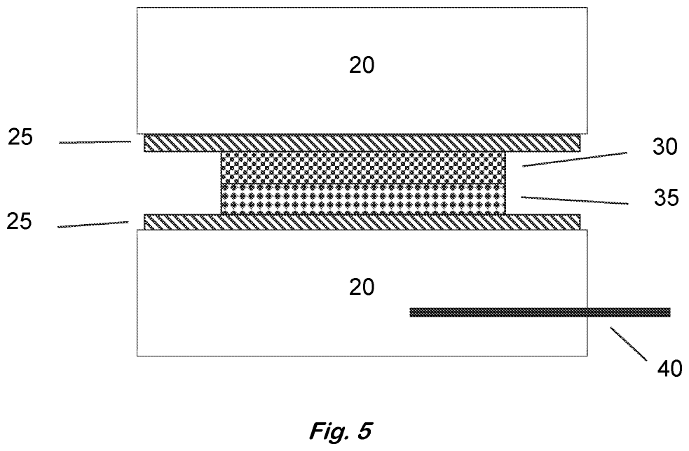

Fabrication of graded/gradient pore carbon nanofoams—A piece of fiber-reinforced Teflon (FIG. 5, 25) was placed on top of an Al platen 20. Two pieces of polymer nanofoam-filled carbon-fiber papers of distinct pore size distributions (e.g., 50/500+40/1500) 30, 35 were placed on top of each other on the fiber-reinforced Teflon sheet 25 and subsequently covered with a second fiber-reinforced Teflon sheet 25, followed by a second Al platen 20. The whole assembly was inserted into a hydraulic press with top and bottom plates set to 140° ° C. The temperature set point may also be, for example, in the range of 80-140° C. A thermocouple 40 was inserted into the bottom Al platen through a pre-drilled hole. The pressure on the Al platen assembly was set to 422 psi. Once the thermocouple measured 140° C. (˜5 minutes), the assembly was left at 422 psi for 10 min. The pressure may also be, for example, in the range of 100-1000 psi for 2-10 minutes. The pressure was then released and the Al platen assembly removed and allowed to cool to room temperature under ambient laboratory conditions. The graded/gradient polymer nanofoam paper was removed from the fiber-reinforced Teflon sheets and pyrolyzed under an argon atmosphere at 1000° C. for 2 h (1° C. min⁻¹ ramp rate), producing the graded/gradient carbon nanofoam paper. Graded/gradient nanofoam papers are denoted as nanofoam #1|nanofoam #2 (e.g., 50/500|40/1500).

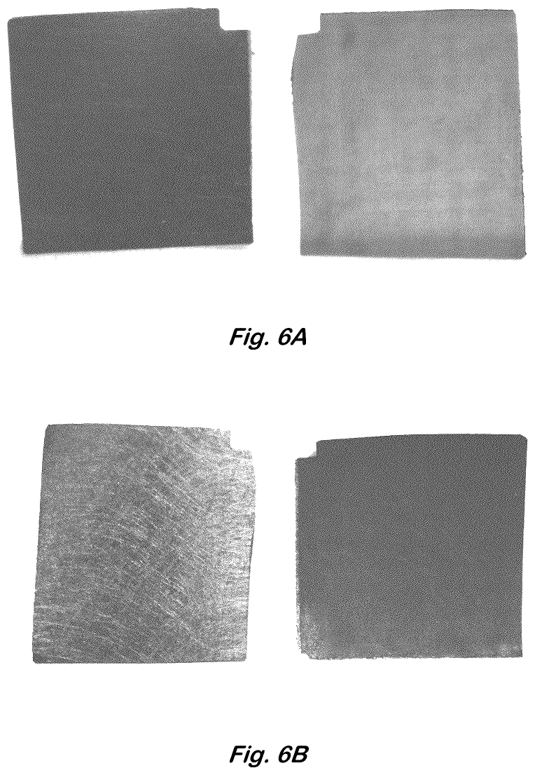

Characterization of morphology—After hot-pressing, the polymer nanofoams within the multilayer paper were well adhered to each other. No cracks or deformation to the macroscale morphology was observed after hot-pressing of the polymer nanofoam-filled papers at 140° ° C. and 422 psi (FIG. 6A, left). No significant shrinkage of the graded polymer nanofoam was detected after pyrolysis at 1000° C. in argon (FIG. 6B). These findings were consistent regardless of the identity of the RF recipe of the polymer nanofoams used to produce the graded/gradient carbon nanofoam.

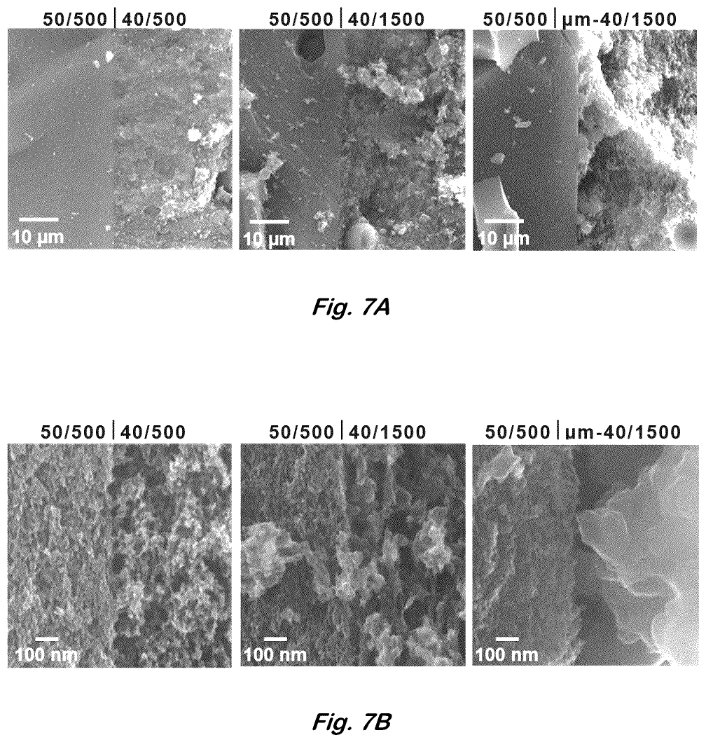

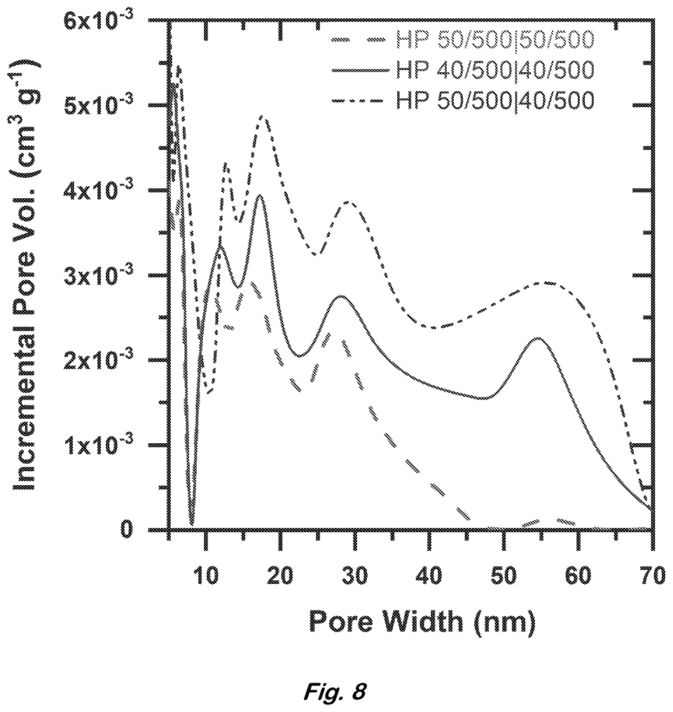

Scanning electron microscopy of the cross-section of the graded pore carbon nanofoam papers reveals a distinct interface between the two carbon nanofoams (FIG. 7A). In all micrographs, the 50/500 carbon nanofoam (2-45 nm pores) is on the left side and the larger pore nanofoams are on the right side (e.g., 40/500: 2-70 nm pores; 40/1500: 2-100 nm; μm-40/1500: 2-1000 nm). Closer examination at high magnification reveals intimate contact is formed between the solid carbon network of the 50/500 nanofoam and the solid networks of the larger pore carbon nanofoams (FIG. 7B).

Nitrogen-sorption porosimetry provides a quantitative analysis of the BET surface area and pore structure of hot-pressed symmetric (e.g., 50/500|50/500 and 40/500|40/500) and graded pore (e.g., 50/500|40/500) carbon nanofoam papers (FIG. 8). The hot-pressed symmetric carbon nanofoam papers serve as a control to examine the influence of hot-pressing two pore-structure dissimilar nanofoam papers together to determine if the pore structure of one of the carbon nanofoams is preferentially altered. Changes in the micropore structure (0.5-2 nm) for all samples examined were statistically insignificant, as expected. Differences arise between symmetric and graded multilayer papers for pores larger than 5 nm. The hot-pressed symmetric 50/500|50/500 carbon nanofoam contains pores ranging from 2-45 nm, while the hot-pressed 40/500|40/500 carbon nanofoam contains pores ranging from 2-70 nm. The graded 50/500|40/500 carbon nanofoam contains a pore size distribution similar to the hot-pressed symmetric 40/500|40/500 carbon nanofoam with pores ranging from 2-70 nm. The pore volume at all pore sizes is larger for the graded 50/500|40/500 carbon nanofoam. The BET surface area is similar for the hot-pressed symmetric 50/500|50/500 and the graded pore 50/500|40/500 carbon nanofoams at 413 and 416 m² g⁻¹, respectively, while it is expectedly lower (346 m² g⁻¹) for the hot-pressed 40/500|40/500 carbon nanofoam because of the presence of larger pores.

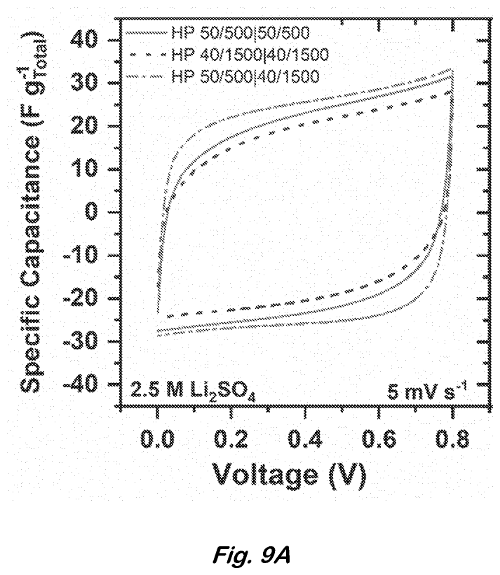

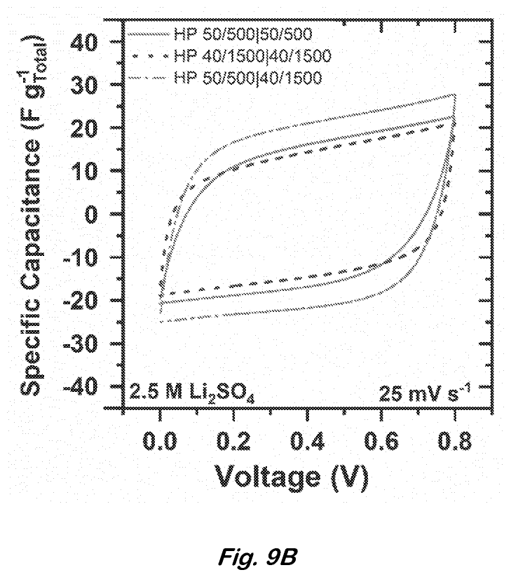

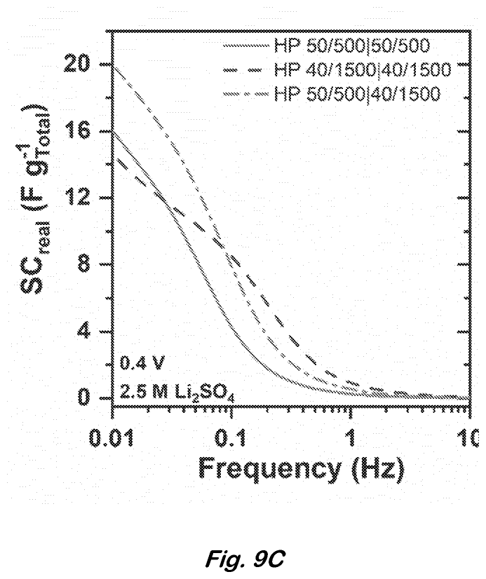

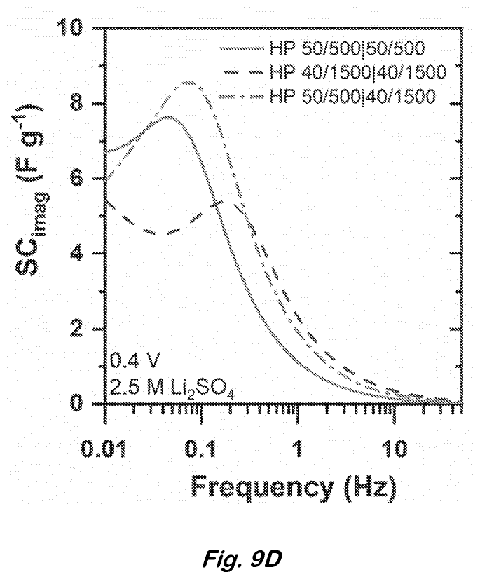

Electrochemical characterization—The influence of the pore structure on electrochemical performance was assessed by fabricating and testing symmetric electrochemical capacitors (ECs) with MnOx-carbon nanofoam paper (designated MnOx-CNF) versus MnOx-CNF in which the carbon nanofoam structure exists as either a graded pore carbon nanofoam (50/500|40/1500) or a hot-pressed symmetric carbon nanofoam control (i.e., 50/500|50/500 or 40/1500|40/1500). Previously reported methods were used to incorporate MnOx into the graded/gradient pore carbon nanofoam, prior to assembly into two-terminal cells (Fischer et al., Incorporation of homogeneous, nanoscale MnO₂ within ultraporous carbon structures via self-limiting electrodeposition: Implications for electrochemical capacitors. Nano Lett., 7, 281 (2007)). Cyclic voltammograms of all ECs display a semi-rectangular shape at 5 mV s⁻¹ (FIG. 9A). The graded pore 50/500|40/1500 EC has a higher specific capacitance than the 50/500|50/500 EC, 21 verses 24 F g⁻¹, respectively, despite similar MnOx loadings (58 vs 56 wt. %, respectively). The higher capacitance of the graded pore 50/500|40/1500 EC is attributed to its larger pore volume, 0.61 cm³ g⁻¹ versus 0.52 cm³ g⁻¹, which ensures adequate supply of ions to the MnOx to balance the electron charge of the pseudocapacitive charge-storage reaction (Sassin et al., Designing high-performance electrochemical energy-storage nanoarchitectures to balance rate and capacity. Nanoscale, 5, 1649 (2013)). At 25 mV s⁻¹, the importance of a graded pore structure becomes more apparent. The graded pore 50/500|40/1500 EC delivers 18 F g⁻¹ compared to 13 F g⁻¹ for the hot-pressed 50/500|50/500 revealing that the larger pores of the 40/1500 in the graded pore 50/500|40/1500 EC provides sufficient electrolyte volume (and thus moles of ions) to balance the pseudocapacitance at the faster scan rates.

The frequency response of the electrochemical capacitors was investigated using electrochemical impedance spectroscopy. The Bode plot of the real component of specific capacitance versus frequency shows that the EC prepared using graded pore 50/500|40/1500 electrodes delivers higher capacitance than the EC prepared with hot-pressed symmetric 50/500|50/500 electrodes at all frequencies (FIG. 9C), despite similar MnOx loadings, again substantiating that the graded pore framework facilitates ion access to the MnOx domains. As expected, the EC equipped with graded pore 50/500|40/1500 electrodes has higher capacitance than the EC prepared using hot-pressed symmetric 40/1500|40/1500 electrodes because of the higher MnOx loading, and that additional capacitance is accessible at frequencies as high as 100 mHz.

The time response of the electrochemical capacitor is extracted from the Bode plot of the imaginary component of capacitance versus frequency (FIG. 9D). The EC prepared using hot-pressed symmetric 40/1500|40/1500 electrodes delivers the lowest capacitance, 5 F g⁻¹, a consequence of the lower MnOx loading, but this still-reasonable capacitance is delivered in just 5 seconds. The highest capacitance, 9 F g⁻¹, is delivered in 12.5 seconds by the EC equipped with graded pore 50/500|40/1500 electrodes, while the hot-pressed symmetric 50/500|50/500 EC delivers 7.5 F g⁻¹ in 20 seconds, even though the electrodes in both devices have similar MnOx loadings. The graded pore structure enables faster delivery of higher capacitance.

Hot-pressing of two or more freestanding polymer nanofoam-filled papers with different pore structures provides a simple and scalable fabrication method to produce carbon nanofoams with a graded/gradient pore structure throughout the thickness of the final object. The advantage of this method is that the pore structure of the individual polymer nanofoams can be pre-selected so that the resulting graded/gradient pore structure yields the desired performance characteristics (e.g., capacity, rate). It is also feasible to fabricate structures in which the pore structure alternates throughout the thickness of the object. The use of freestanding nanofoams ensures that through-connected pathways for electrons are wired in the final object and that the final object also contains a through-connected pore structure to facilitate incorporation of electroactive moieties and subsequent operation in electrochemical devices where transport of ions/molecules to the electroactive moieties are essential. The freestanding nature of the disclosed object coupled with the through-connected pore structure of the graded/gradient carbon nanofoam enable existing simple synthetic protocols to be used to incorporate electrochemically active materials (e.g., metal oxides, conducting polymers, metals, and nanoscale solid-state electrolytes) without adaptations, turning these graded/gradient carbon nanofoams into device-ready, binder-free electrodes for supercapacitors, batteries, and fuel cells.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

1. A laminated article comprising:
a first layer comprising a first porous carbon scaffold and a first porous pyrolyzed polymer; and
a second layer comprising a second porous carbon scaffold and a second porous pyrolyzed polymer;
wherein at least one of the first porous carbon scaffold and the second porous carbon scaffold is carbon fiber paper wherein the first porous pyrolyzed polymer comprises first pores that are from 1 nanometer to 10 microns in diameter;
wherein the first porous pyrolyzed polymer has a first pore size distribution;
wherein the second porous pyrolyzed polymer comprises second pores that are from 1 nanometer to 10 microns in diameter;
wherein the second porous pyrolyzed polymer has a second pore size distribution; and
wherein the first pore size distribution and the second pore size distribution are different.

2. The article of claim 1, further comprising:
one or more additional layers each comprising an additional porous carbon scaffold and an additional porous pyrolyzed polymer having an additional pore size distribution;
wherein all of the first pore size distribution, the second pore size distribution, and the one or more additional pore size distributions are different from each other.

3. The article of claim 2, wherein the first pore size distribution, the second pore size distribution, and the one or more additional pore size distributions create a pore size gradient from a first surface of the article to a second surface of the article.

4. The article of claim 1, further comprising:
one or more additional layers each comprising an additional porous carbon scaffold and an additional porous pyrolyzed polymer having an additional pore size distribution that is the same as the first pore size distribution or the second pore size distribution; and
wherein the first pore size distribution, the second pore size distribution, and the one or more additional pore size distributions alternate between the first pore size distribution and the second pore size distribution from a first surface of the article to a second surface of the article.

5. The article of claim 1, wherein the first pores or the second pores are part of a connected network of pores permeating the article.

6. The article of claim 1, further comprising:
manganese oxide deposited on the first porous pyrolyzed polymer, the second porous pyrolyzed polymer, or both.

7. An electrochemical cell comprising the article of claim 1.

8. A method comprising:
providing a first layer comprising a first porous carbon scaffold and a first porous polymer;
providing a second layer comprising a second porous carbon scaffold and a second porous polymer;
forming a laminated article comprising the first layer and the second layer; and
pyrolyzing the laminated article to form a pyrolyzed article wherein at least one of the first porous carbon scaffold and the second porous carbon scaffold is carbon fiber paper
wherein the first porous polymer comprises first pores that are from 1 nanometer to 10 microns in diameter;
wherein the first porous polymer has a first pore size distribution;
wherein the second porous polymer comprises second pores that are from 1 nanometer to 10 microns in diameter;
wherein the second porous polymer has a second pore size distribution; and
wherein the first pore size distribution and the second pore size distribution are different.

9. The method of claim 8, further comprising:
providing one or more additional layers each comprising an additional porous carbon scaffold and an additional porous polymer having an additional pore size distribution;
wherein the one or more additional layers are laminated with the first layer and the second layer; and
wherein all of the first pore size distribution, the second pore size distribution, and the one or more additional pore size distributions are different from each other.

10. The method of claim 9, wherein the first pore size distribution, the second pore size distribution, and the one or more additional pore size distributions create a pore size gradient from a first surface of the laminated article to a second surface of the laminated article.

11. The method of claim 8, further comprising:
providing one or more additional layers each comprising an additional porous carbon scaffold and an additional porous polymer having an additional pore size distribution that is the same as the first pore size distribution or the second pore size distribution;
wherein the one or more additional layers are laminated with the first layer and the second layer; and
wherein the first pore size distribution, the second pore size distribution, and the one or more additional pore size distributions alternate between the first pore size distribution and the second pore size distribution from a first surface of the laminated article to a second surface of the laminated article.

12. The method of claim 8, wherein the first porous polymer or the second porous polymer comprises a polymer of resorcinol and formaldehyde.

13. The method of claim 8, wherein the first pores or the second pores are part of a connected network of pores permeating the pyrolyzed article.

14. The method of claim 8, further comprising:
depositing manganese oxide into the pyrolyzed article.

15. The method of claim 8, wherein forming the laminated article is performed by hot pressing.
